(19) United States
(12) Patent Application Publication
(10) Pub. No.: US 2012/0022823 A1
(43) Pub. Date: Jan. 26, 2012

(54) ELECTRONIC COMPASS

(76) Inventor: Fouad Bennini, Reutlingen (DE)

(21) Appl. No.: 12/998,376

(22) PCT Filed: Aug. 25, 2009
(86) PCT No.: PCT/EP2009/060927

§ 371 Date: Jun. 20, 2011

(30) Foreign Application Priority Data
Oct. 21, 2008 (DE) 102008042989.9

(51) Int. Cl. G06F 15/00

(52) U.S. Cl. 702/141; 702/150

(57) ABSTRACT

A method for determining a null drift (Hx0, Hy0) of an electronic compass includes steps for ascertaining first magnetic field strengths in a first coordinate system of the electronic compass via a triaxial magnetic sensor; for calculating from the first magnetic field strengths incline-compensated second magnetic field strengths (200) in a second coordinate system (x, y) parallel to the Earth's surface; for adjusting a trial function (210) to the incline-compensated second magnetic field strengths (200); and for determining a null drift (Hx0, Hy0) from the adjusted trial function (210). A method for operating the electronic compass includes steps for calculating an incline-compensated magnetic field strength (Hx, Hy) in the second coordinate system (x, y) from a first magnetic field strength measured by the magnetic sensor, for calculating a zero-point-corrected third magnetic field strength (Bx, By) by subtracting the null drift (Hx0, Hy0) determined by the above-described method from the incline-compensated second magnetic field strength (Hx, Hy); and for calculating an azimuth angle by which an axis (x) of the second coordinate system (x, y) deviates from a north-south direction.

### BACKGROUND OF THE INVENTION

1. Field of the Invention

The present invention relates to a method for determining a null drift of an electronic compass, a method for operating an electronic compass, and an electronic compass.

2. Description of Related Art

Magnetic sensors may be used to measure the Earth's magnetic field and are thus suitable for use in electronic compasses. Since the Earth's magnetic field runs parallel to the Earth's surface, a magnetic sensor that can ascertain the Earth's magnetic field along at least two axes perpendicular to each other is required. In this case, the electronic compass must be kept parallel to the Earth's surface. When a triaxial magnetic sensor is used, an incline of the electronic compass relative to the Earth's surface can be calculated out.

Since the strength of the Earth's magnetic field is in the range of only some ten μT, very sensitive magnetic sensors, which are accordingly susceptible to stray fields, are required. Such stray fields may be caused by nearby electric lines or ferromagnetic materials and result in an additional magnetic field component that is superimposed on the Earth's magnetic field. This results in an error in the evaluation of the measured signals and thus in an erroneous ascertainment of the cardinal directions.

Printed publication US 2007/0276625 A1 describes an electronic compass having a triaxial magnetic sensor that allows for an automatic correction of a null drift. To this end, the electronic compass collects magnetic field strengths measured at different orientations of the electronic compass and plots their spatial components in a three-dimensional Cartesian coordinate system. Subsequently, an attempt is made to approximate the distribution of the measurement values in the three-dimensional coordinate system using a spherical shell. A null drift of the electronic compass caused by interferences is inferred from a deviation of the middle point of the spherical shell from the origin of the coordinate system. Due to the direct processing of the three-dimensional magnetic sensor data, complicated and error-prone algorithms are required.

### SUMMARY OF THE INVENTION

The objective of the present invention is to specify an improved method for determining a null drift of an electronic compass. It is furthermore the objective of the present invention to specify an improved method for operating an electronic compass. It is furthermore the objective of the present invention to provide an improved electronic compass.

A method according to the present invention for ascertaining a null drift of an electronic compass includes steps for ascertaining a plurality of first magnetic field strengths in a first coordinate system of the electronic compass via a triaxial magnetic sensor, for calculating a plurality of incline-compensated second magnetic field strengths in a second coordinate system parallel to the Earth's surface from the plurality of first magnetic field strengths, for adjusting a trial function to the plurality of incline-compensated second magnetic field strengths, and for determining a null drift from the adjusted trial function. This method advantageously reduces the determination of the null drift from a three-dimensional problem to a two-dimensional problem. This simplifies the adjustment of the trial function. Advantageously, the second magnetic field strengths are incline-compensated already, which simplifies the determination of the null drift.

Preferably, for calculating the plurality of incline-compensated second magnetic field strengths, for each first magnetic field strength steps are taken to determine a bank angle and a pitch angle of the first coordinate system relative to the second coordinate system and to calculate the incline-compensated second magnetic field strength from the first magnetic field strength, the bank angle, and the pitch angle.

According to a further refinement of the method, to determine the bank angle and the pitch angle steps are taken to ascertain an acceleration value in the first coordinate system via a triaxial acceleration sensor and to calculate the bank angle and the pitch angle of the first coordinate system relative to the second coordinate system. Advantageously, by this means, the orientation of the electronic compass relative to the Earth's surface is ascertained via an acceleration sensor that is independent of the magnetic sensor, which increases the robustness of the method.

In one specific embodiment, the ascertained acceleration value is filtered by a low-pass filter before the further processing. By this means, it is possible to suppress disruptive movements during the recording of measurement data, which increases the precision of the method.

A circular function is advantageously used as a trial function.

According to one specific embodiment of the method, the electronic compass is moved during the recording of the plurality of first magnetic field strengths, swiveled, for example. This is appropriate for portable devices such as mobile phones, for example.

A method according to the present invention for operating an electronic compass includes steps for determining a null drift of the electronic compass according to a method described above, for ascertaining a first magnetic field strength in a first coordinate system of the electronic compass via a triaxial magnetic sensor, for calculating from the first magnetic field strength an incline-compensated second magnetic field strength in a second coordinate system parallel to the Earth's surface, for calculating a zero-point-corrected third magnetic field strength by subtracting the null drift from the incline-compensated second magnetic field strength, and for calculating an azimuth angle, by which an axis of the second coordinate system deviates from a north-south direction. The azimuth angle determined according to this method by the electronic compass is advantageously zero-point-corrected, that is, freed from possible disruptive influences.

An electronic compass according to the present invention includes a triaxial magnetic sensor and a triaxial acceleration sensor and is designed to implement the above-described method for determining a null drift.

The electronic compass is preferably also designed to implement the described method for operating the electronic compass.

According to one specific embodiment, the magnetic sensor includes at least one GMR sensor.

In another specific embodiment, the acceleration sensor includes at least one micromechanical acceleration sensor.

### BRIEF DESCRIPTION OF THE DRAWINGS

FIG. 1 shows a schematic representation of an electronic compass.

FIG. 2 shows a schematic interior view of an electronic compass.

FIG. 3 shows a schematic representation of the characteristic of an incline-compensated second magnetic field strength when the electronic compass is rotated 360°.

FIG. 4 shows an alternative representation of the characteristic of the incline-compensated second magnetic field strength.

FIG. 5 shows a schematic representation of non-zero-point-corrected second magnetic field strengths and zero-point-corrected third magnetic field strengths.

FIG. 6 shows a schematic flow chart of a method for determining a null drift.

FIG. 7 shows a schematic flow chart of a method for calculating incline-compensated magnetic field strengths.

FIG. 8 shows a schematic flow chart of a method for determining bank angle and pitch angle.

FIG. 9 shows a schematic flow chart of a method for operating an electronic compass.

### DETAILED DESCRIPTION OF THE INVENTION

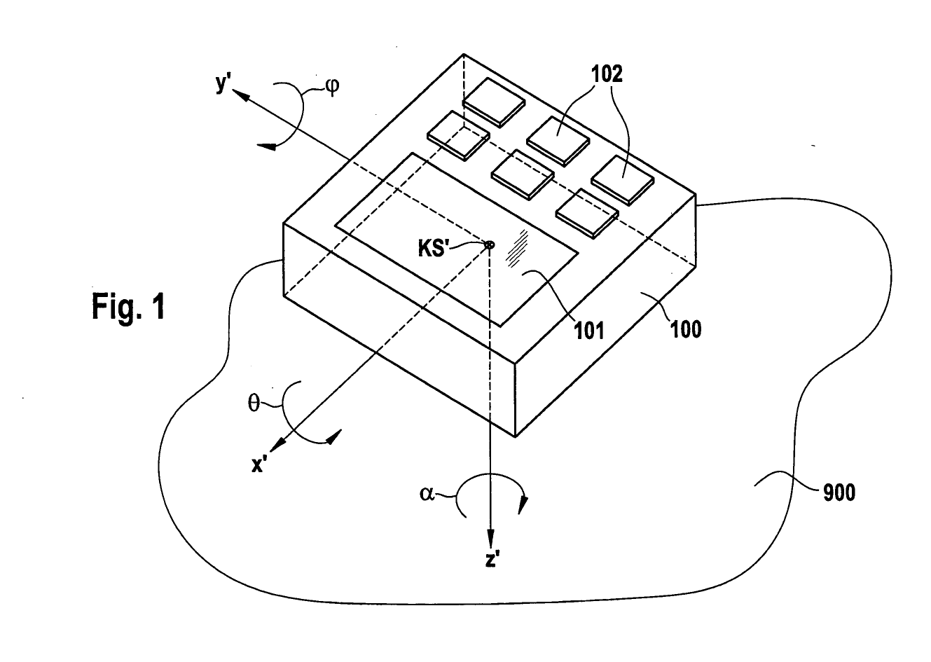

FIG. 1 shows a schematic view of an electronic compass 100. Electronic compass 100 may have a screen 101 for displaying the cardinal directions ascertained by electronic compass 100. Electronic compass 100 can also have operating elements 102, for example, one or a plurality of operator keys. Operating elements 102 make it possible to operate electronic compass 100. Electronic compass 100 may be integrated in another portable or non-portable electronic device, for example, a mobile phone, a personal digital assistant (PDA), a navigation device, or a wrist watch.

A first coordinate system KS′ may be thought of as being permanently connected to electronic compass 100. First coordinate system KS′ has three axes x′, y′, z′ that are perpendicular to each other. From electronic compass 100, the x′ axis points forward, the y′ axis points to the side, and the z′ axis points down. A rotation of the electronic compass around the x′ axis corresponds to a change of a bank angle 8. A rotation of electronic compass 100 around the y′ axis corresponds to a change of pitch angle φ. A rotation of electronic compass 100 around the z′ axis corresponds to a change of an azimuth angle α.

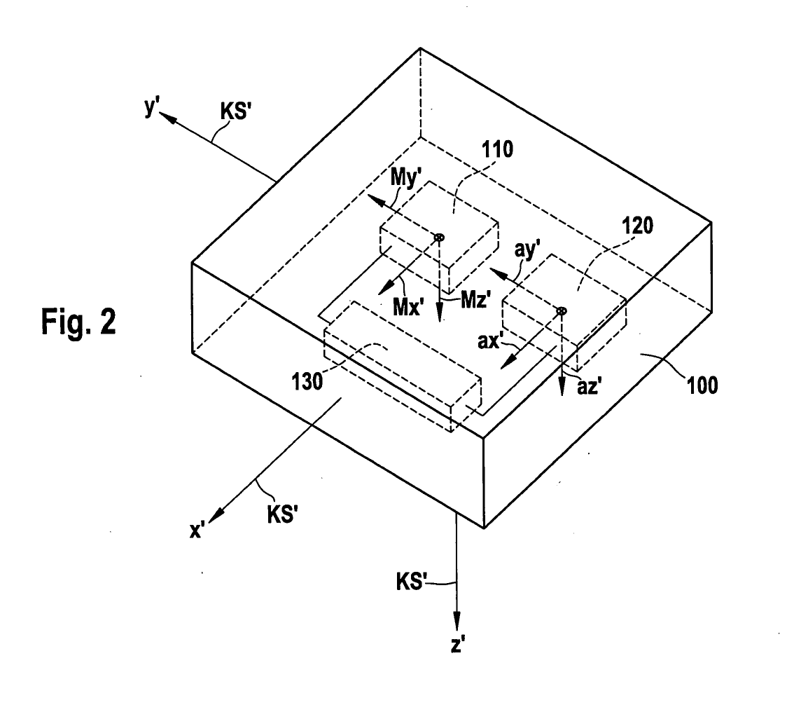

FIG. 2 illustrates a schematic view of the components contained in electronic compass 100. Electronic compass 100 has a triaxial magnetic sensor 110 and a triaxial acceleration sensor 120. Furthermore, evaluation electronics 130 exist, which are connected to magnetic sensor 110 and acceleration sensor 120. Magnetic sensor 110 may have Hall probes, GMR sensors, fluxgate sensors, or other suitable magnetic sensors, for example. Acceleration sensor 120 may have micromechanical acceleration sensors, for example. Evaluation electronics 130 may have a microprocessor, a microcontroller, or other suitable electronic components. Suitable components are known to one skilled in the art from the related art.

Magnetic sensor 110 is designed to ascertain the strength of a magnetic field in all three spatial directions of first coordinate system KS′ connected to electronic compass 100. Magnetic sensor 110 thus ascertains a first magnetic field strength M′ having components Mx′ in the direction of the x′ axis, My′ in the direction of the y′ axis, and Mz′ in the direction of the z′ axis. Acceleration sensor 120 is designed to measure the magnitude of an acceleration acting on electronic compass 100 in all three spatial directions of first coordinate system KS′ connected to electronic compass 100. Acceleration sensor 120 thus ascertains a first acceleration value a′ having components ax′ in the direction of the x′ axis, ay′ in the direction of the y′ axis, and az′ in the direction of the z′ axis.

Since only gravitational acceleration acts on stationary electronic compass 100, and this acts in a direction perpendicular to the Earth's surface, evaluation electronics 130 can infer from components ax′, ay′, az′ of ascertained acceleration value a′ the orientation of first coordinate system KS′ connected to electronic compass 100 relative to a second coordinate system KS having axes x, y, z. The x-y plane of second coordinate system KS is oriented parallel to Earth's surface 900. The x axis of the second coordinate system is rotated by the same azimuth angle α as the x′ axis of first coordinate system KS′, relative to a north-south direction of Earth's surface 900. For example, evaluation electronics 130 can calculate a bank angle θ and a pitch angle φ, by which second coordinate system KS must be rotated around the x and y axes, in order to transfer it into first coordinate system KS′. For example, the calculation can be performed according to the following formulas:

θ=1/tan(ay′/sqrt(ax′ax′+az′az′));

φ=1/tan(ax′/sqrt(ay′ay′+az′az′)). (1)

Apart from this, evaluation electronics 130 can calculate from first magnetic field strength M′ in first coordinate system KS′ a second magnetic field strength H having components Hx in the direction of the x axis of second coordinate system KS and Hy in the direction of the y axis of second coordinate system KS. For example, the calculation can be performed using the following formula:

Hx=Mx′ cos(φ)+My′ sin(φ)sin(θ)−Mz′ sin(φ)cos(θ);

Hy=My′ cos(θ)+Mz′ sin(θ). (2)

Evaluation electronics 130 can also calculate a component Hz of second magnetic field strength H in the direction of the z axis of second coordinate system KS. Since the Earth's magnetic field runs parallel to Earth's surface 900, that is, inside of the x-y plane of second coordinate system KS, component Hz of second magnetic field strength H should be equal to zero. Otherwise, it can be inferred that an error exists.

Since the Earth's magnetic field runs in the north-south direction of Earth's surface 900, evaluation electronics 130 can infer from components Hx, Hy of second magnetic field strength H the size of azimuth angle α, that is, the deviation of the direction of the x axis of second coordinate system KS from the north-south direction. For example, the calculation of the azimuth angle α can be performed using the following formula:

α=arctan(Hy/Hx). (3)

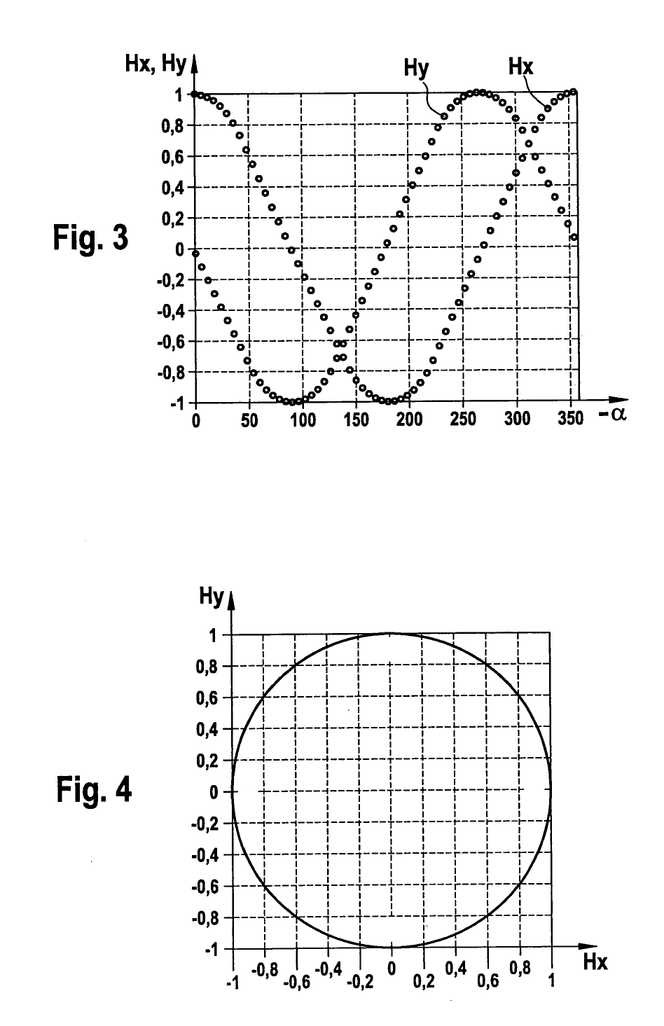

FIG. 3 illustrates schematically the expected characteristic of components Hx, Hy of second magnetic field strength H as a function of azimuth angle α. If electronic compass 100 is oriented toward the south, then component Hx pointing in x direction of second coordinate system KS should take on a maximum, while component Hy pointing in the y direction is equal to zero. If electronic compass 100 is oriented toward the west, the x component of second magnetic field strength H is equal to zero, while the y component takes on a minimum. If electronic compass 100 is held in the direction of the north, then the x component of second magnetic field strength H takes on a minimum, while the y component is equal to zero. If electronic compass 100 points towards the east, then y component Hy takes on a maximum, while x component Hx is equal to zero.

FIG. 4 illustrates the expected characteristic of components Hx, Hy of second magnetic field strength H in an alternative representation. In FIG. 4, expected second magnetic field strength H is illustrated parametrically as a function of azimuth angle α in the Hx-Hy plane. A circle results, which is formed by the possible value pairs of components Hx, Hy of second magnetic field strength H.

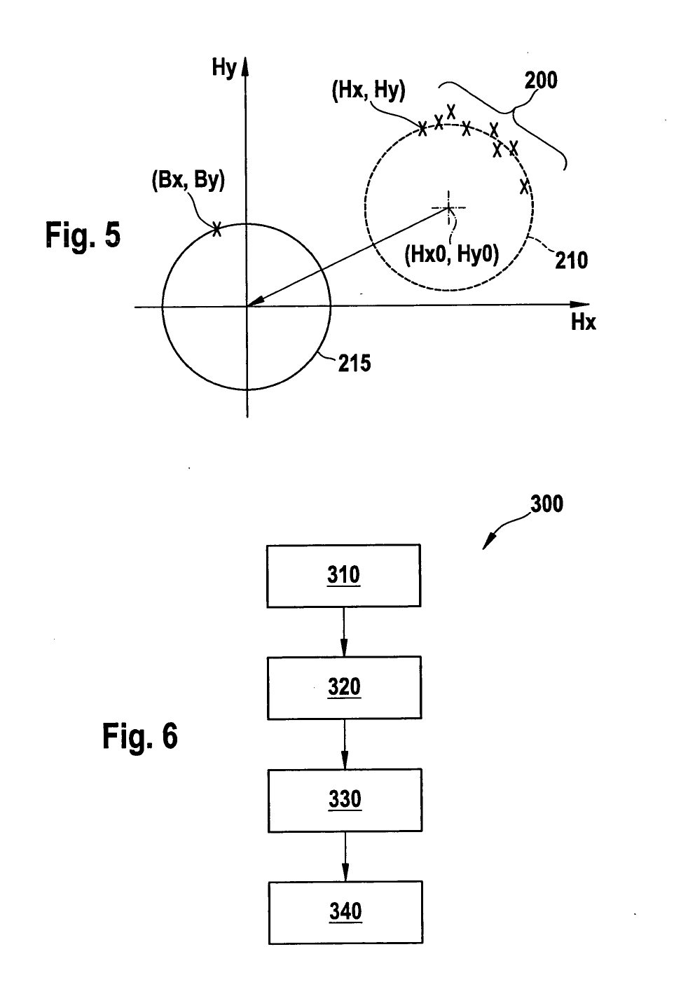

If the Earth's magnetic field in the surroundings of electronic compass 100 is distorted or locally disrupted by a magnetic source of interference, then second magnetic field strengths H ascertained by electronic compass 100 are not on a circle around the zero point in the Hx-Hy plane, but rather on a circle whose middle point is shifted relative to the zero point by a null drift Hx0, Hy0. This is depicted schematically in FIG. 5. FIG. 5 illustrates a section of the Hx-Hy plane, in which a number of measurement values 200 of second magnetic field strength H is drawn in by way of example. Each of measured values 200 shown was ascertained at a different orientation of electronic compass 100 relative to Earth's surface 900. Due to the existence of a magnetic stray field in the surroundings of electronic compass 100, measurement values 200 are not on a circle around the origin of the Hx-Hy plane. If the ascertained measurement values 200 are used to determine the azimuth angle α according to formula (3), then a false azimuth angle α results due to the magnetic interference in the surroundings of electronic compass 100. Thus, measurement values 200 should initially be corrected by the amount of null drift Hx0, Hy0.

Since measurement values 200 are distributed in a circle around null drift Hx0, Hy0, a trial function 210 may be adjusted to measurement values 200 to determine null drift Hx0, Hy0, and null drift Hx0, Hy0 can be determined from the adjusted trial function 210. For example, a circular function having a fixed or adjustable radius is suitable as a trial function. If a circular function is used as a trial function, then null drift Hx0, Hy0 results as the middle point of the adjusted circular function. Null drift Hx0, Hy0 ascertained in this manner can subsequently be subtracted from measurement values 200, which results in zero-point-corrected third magnetic field strengths Bx, By, which are situated along an expected measurement value distribution 215 around the origin of the Hx-Hy plane. Subsequently, the correct azimuth angle α can be calculated from a zero-point-corrected third magnetic field strength Bx, By according to the following formula:

α=arctan(By/Bx). (4)

FIG. 6 explains a method 300 for determining a null drift of an electronic compass 100, as may be implemented by electronic compass 100. In a first method step 310, electronic compass 110 ascertains via triaxial magnetic sensor 110 a plurality of first magnetic field strengths M′ having components Mx′, My′, Mz′ in first coordinate system KS′, which is permanently connected to electronic compass 100. First magnetic field strengths M′ are preferably recorded at different orientations of electronic compass 100. For example, electronic compass 100 may be rotated or swiveled during the ascertainment of the plurality of first magnetic field strengths M′.

In subsequent method step 320, a plurality of incline-compensated second magnetic field strengths H having components Hx, Hy in a second coordinate system KS parallel to the Earth's surface 900 are calculated from the plurality of first magnetic field strengths M′. For example, this can be performed using method 400 described below with the aid of FIG. 7.

In an additional method step 330, a trial function 210 is adjusted to the plurality of incline-compensated second magnetic field strengths H. A circular function may be used as trial function 210, for example. The radius of the circle may be fixed and correspond to the expected amount of the Earth's magnetic field strength or may be adjusted to the values of the incline-compensated second magnetic field strengths H.

In a further method step 340, null drift Hx0, Hy0 is determined from adjusted trial function 210. If a circular function is used as trial function 210, then null drift Hx0, Hy0 results as the middle point of the adjusted circular function.

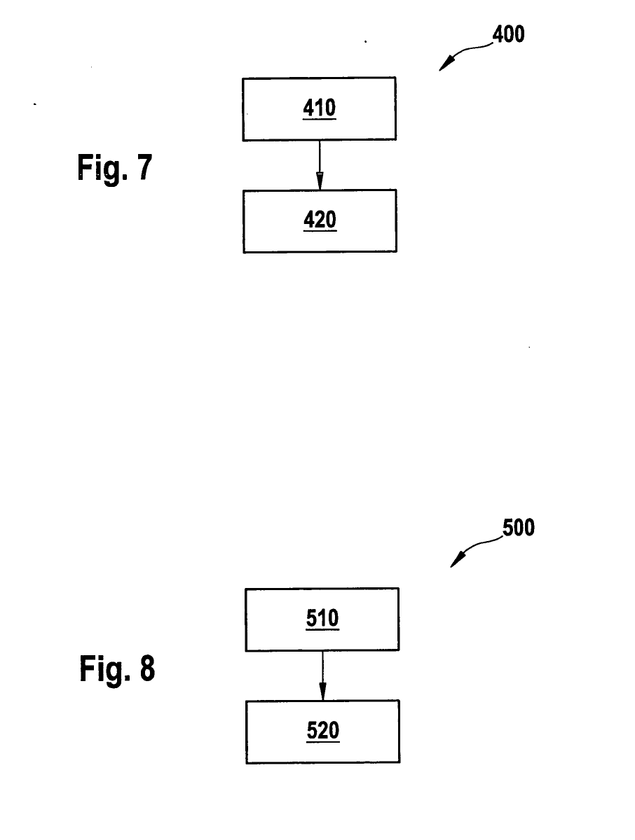

FIG. 7 illustrates a schematic flow chart of method 400 for calculating a plurality of incline-compensated second magnetic field strengths H relating to a second coordinate system KS from a plurality of first magnetic field strengths M′ relating to a first coordinate system KS′. Method 400 is implemented for each first magnetic field strength M′, in order to calculate therefrom an incline-compensated second magnetic field strength H. To this end, a bank angle θ and a pitch angle φ of first coordinate system KS′ relative to second coordinate system KS is determined in a first method step 410. For example, this can be performed using method 500 explained below with the aid of FIG. 8.

In an additional method step 420, the incline-compensated second magnetic field strength H is calculated from first magnetic field strength M′, bank angle θ, and pitch angle φ. This can be done using the above-mentioned formula (2), for example.

FIG. 8 illustrates a schematic flow chart of method 500 for determining bank angle θ and pitch angle φ. The method includes a method step 510 for ascertaining an acceleration value a′ having components ax′, ay′, az′ in first coordinate system KS′ via triaxial acceleration sensor 120.

In an additional method step 520, bank angle θ and pitch angle φ of first coordinate system KS′ relative to second coordinate system KS are calculated from the ascertained acceleration value a′. This calculation may be performed using the above-mentioned formula (1), for example.

Bank angle θ and pitch angle φ should preferably be determined separately for each measurement value M′ that is to be converted into an incline-compensated magnetic field value H. This means that for each magnetic field value M′, an acceleration value a′ is also recorded at the same orientation of electronic compass 100 relative to Earth's surface 900.

In a further refinement of method 500, the ascertained acceleration value a′ can run through a low-pass filter between method steps 510 and 520, in order to suppress disruptive movements during the recording of measurement data. For example, if electronic compass 100 is shaken strongly, then centrifugal forces occur, which superimpose the gravitational acceleration acting on electronic compass 100 and falsify the measurement result. By using a low-pass filter, such falsifications can be filtered out.

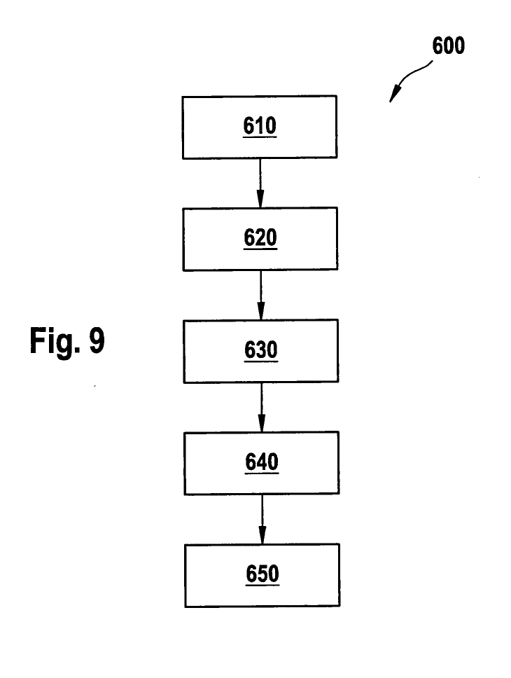

FIG. 9 illustrates a schematic flow chart of a method 600 for operating electronic compass 100. Method 600 includes a method step 610 for determining a null drift Hx0, Hy0 of electronic compass 100. For example, this can be done using method 300 described above with the aid of FIG. 6.

In an additional method step 620, a first magnetic field strength M′ in first coordinate system KS′ of electronic compass 100 is ascertained via triaxial magnetic sensor 110.

In an additional method step 630, an incline-compensated second magnetic field strength H in coordinate system KS, which is parallel to Earth's surface 900, is calculated from first magnetic field strength M′. For example, this can take place through method 400 described above with the aid of FIG. 7.

In an additional method step 640 a zero-point-corrected third magnetic field strength B is calculated by subtracting null drift Hx0, Hy0 from incline-compensated second magnetic field strength H.

In a subsequent method step 650, azimuth angle α is calculated from third magnetic field strength B having components Bx, By, by which the x-axis of second coordinate system KS deviates from the north-south direction of Earth's surface 900. This can be performed using formula (4), for example. For example, azimuth angle α ascertained in this manner may be displayed on screen 101 of electronic compass 100.

Electronic compass 100 can implement the described method for determining the null drift periodically or at the command of a user operating electronic compass 100. However, electronic compass 100 can also continually implement the described method for determining the null drift. In this specific embodiment, each measurement value measured by electronic compass 100 can be utilized for the permanent comparison of the null drift. It may also be provided that measurement data that strongly deviate from the present characteristic of the measurement values are filtered out, in order to suppress short-term disruptions.

The described method for determining the null drift of electronic compass 100 is suitable for compensating internal and external disruptions of electronic compass 100. An internal disruption is brought about by a stray magnetic field generated inside of electronic compass 100. An external disruption is caused by a stray magnetic field in the surroundings of electronic compass 100.

1-14. (canceled)

15. A method for determining a null drift (Hx0, Hy0) of an electronic compass, comprising:
ascertaining a plurality of first magnetic field strengths (Mx′, My′, Mz′) in a first coordinate system (KS′) of the electronic compass via a triaxial magnetic sensor;
calculating a plurality of incline-compensated second magnetic field strengths (Hx, Hy) in a second coordinate system (KS) parallel to the Earth's surface from the plurality of first magnetic field strengths (Mx′, My′ Mz′);
adjusting a trial function to the plurality of incline-compensated second magnetic field strengths (Hx, Hy); and
determining a null drift (Hx0, Hy0) from the adjusted trial function.

16. The method as recited in claim 15, wherein the plurality of incline-compensated second magnetic field strengths (Hx, Hy) for each first magnetic field strength (Mx′, My′, Mz′) are calculated by:
determining a bank angle (θ) and a pitch angle (φ) of the first coordinate system (KS′) relative to the second coordinate system (KS); and
calculating the incline-compensated second magnetic field strength (Hx, Hy) from the first magnetic field strength (Mx′, My′, Mz′), the bank angle (θ) and the pitch angle (φ).

17. The method as recited in claim 16, wherein the incline-compensated second magnetic field strengths (Hx, Hy) are calculated using the following formula:
Hx=Mx′ cos(φ)+My′ sin(φ)sin(θ)−Mz′ sin(φ)cos(θ);
Hy=My′ cos(θ)+Mz′ sin(θ).

18. The method as recited in claim 16, wherein the bank angle (θ) and the pitch angle (φ) are determined by:
ascertaining an acceleration value (ax′, ay′, az′) in the first coordinate system (KS′) via a triaxial acceleration sensor (120); and
calculating the bank angle (θ) and the pitch angle (φ) of the first coordinate system (KS′) relative to the second coordinate system (KS).

19. The method as recited in claim 18, wherein the bank angle (θ) and pitch angle (φ) are calculated according to the following formulas:
θ=1/tan(ay′/sqrt(ax′ax′+az′az′));
φ=1/tan(ax′/sqrt(ay′ay′+az′az′)).

20. The method as recited in claim 18, wherein the ascertained acceleration value (ax′, ay′, az′) is filtered via a low-pass filter prior to further processing.

21. The method as recited in claim 15, wherein a circular function is used as a trial function.

22. The method as recited in claim 15, wherein the electronic compass is moved during the ascertaining of the plurality of first magnetic field strengths (Mx′, My′, Mz).

23. A method for operating an electronic compass, comprising:
determining a null drift (Hx0, Hy0) of the electronic compass according to the method recited in claim 15;
ascertaining a first magnetic field strength (Mx′, My′, Mz′) in a first coordinate system (KS′) of the electronic compass via a triaxial magnetic sensor;
calculating an incline-compensated second magnetic field strength (Hx, Hy) in a second coordinate system (KS) parallel to the Earth's surface from the first magnetic field strength (Mx′, My′ Mz′); and
calculating a zero-point-corrected third magnetic field strength (Bx, By) by subtracting the null drift (Hx0, Hy0) from the incline-compensated second magnetic field strength (Hx, Hy); and
calculating an azimuth angle (α) by which an axis (x) of the second coordinate system (KS) deviates from a north-south direction.

24. The method as recited in claim 23, wherein the azimuth angle (α) is calculated from the third magnetic field strength (Bx, By) according to the following formula:
α=arctan(By/Bx).

25. An electronic compass having a triaxial magnetic sensor and triaxial acceleration sensor, the electronic compass being designed to implement a method for determining a null drift (Hx0, Hy0) as recited in claim 15.

26. The electronic compass as recited in claim 25, the electronic compass being designed to implement the method as recited in claim 23.

27. The electronic compass as recited in claim 25, the magnetic sensor including at least one GMR sensor.

28. The electronic compass as recited in claim 25, the acceleration sensor including at least one micromechanical acceleration sensor.
